(19) United States
(12) Patent Application Publication
(10) Pub. No.: US 2006/0048297 A1
(43) Pub. Date: Mar. 9, 2006

(54) Portable lift device

(76) Inventor: Michael Mills, Ogden, UT (US)

Correspondence Address: TRASK BRITT, P.O. BOX 2550, SALT LAKE CITY, UT, 84110, US

(21) Appl. No.: 11/223,579

(22) Filed: Sep. 9, 2005

Related U.S. Application Data
(60) Provisional application No. 60/608,831, filed on Sep. 9, 2004.

(51) Int. Cl. A61G 7/10

(52) U.S. Cl. 5/86.1

(57) ABSTRACT

A movable lifting device may be used to move a person from one position to another, such as from a wheelchair into a vehicle seat. The device is collapsible such that it may be easily stored or transported and easily assembled for use. The device may include controllable parts for moving the device and operating the device.

This application claims the benefit of U.S. Provisional Application No. 60/608,831, entitled “Transport Device for Disabled Persons” filed Sep. 9, 2004, and incorporates the same herein by reference in its entirety.

### BACKGROUND OF THE INVENTION

### FIELD OF THE INVENTION

The invention relates to structures for assisting the movement of persons. More specifically, the invention is directed to portable devices to assist in the movement of a person from one location to another.

Powered lifting devices are well known and have been used for years to assist in the movement of persons from one location to another. Many nursing homes, hospitals, and individuals purchase lifting devices to assist with the movement of patients from one position to another. For example, lifting devices are used to move patients from wheelchairs into beds or vehicles and back into the wheelchairs. In other instances, lifting devices may be used to support a person for bathing or to support a person during other daily activities if they are not able to support themselves.

Many of the lifting devices that are available are cumbersome and heavy. As a result, lifting devices are often only used in isolated areas and are not easily transportable. For example, a lifting device may be used in a single room for lifting a person from a bed into a wheelchair or into an attached bathroom but the device may be difficult to use elsewhere in a house due to its size. The cumbersome nature of lifting devices makes it impractical to transport or disassemble a lifting device.

Accordingly, it is desirable to provide a lifting device that can be disassembled and that is easily transportable in order to facilitate improved usage of the lifting device.

### SUMMARY OF THE INVENTION

According to some embodiments of the present invention, a lifting device includes a plurality of elements which are detachably connected to one another. The detachable elements may be assembled to form a base frame assembly, a support frame assembly, a lift, and a support structure. The device may be used to move a person, such as a person in a wheelchair, from one location to another.

In some embodiments of the present invention a device for moving people, or a lift device, includes a base frame assembly detachably connected to a support frame assembly. A support structure is also detachably connected to the support frame assembly. A lift, detachably connected to the support frame assembly, may be used to move the support structure and assist with the movement of a person from one position to another. The detachable nature of the components of the device allows for the easy assembly and disassembly of the device for transportation or for storage.

According to other embodiments of the present invention a device for moving people includes at least two legs detachably connected to a support structure. The legs may be solid structures or may include detachable sub-structures that can be detachably connected to form the legs. The legs are detachably connected to a support structure that is also detachably connected to a support extension. The support extension is detachably connected to an extension arm capable of supporting a support structure. A lift, such as an electrically powered lift or hydraulic arm, is detachably connected to the support extension and the extension arm. The lift may be used to move the extension arm relative to the support extension. A support structure may be detachably connected to the extension arm to support a person or to facilitate the movement of a person from one position to another. The detachable nature of the components of the device allows the device to be easily assembled and disassembled for transportation or for storage.

### BRIEF DESCRIPTION OF THE DRAWINGS

While the specification concludes with claims particularly pointing out and distinctly claiming that which is regarded as the present invention, this invention can be more readily ascertained from the following description of the invention when read in conjunction with the accompanying drawings in which:

FIG. 1 illustrates an embodiment of the present invention;

FIG. 2 illustrates a device according to an embodiment of the present invention being used to move a person;

FIG. 3 illustrates a device according to an embodiment of the present invention being used to move a person;

FIG. 4 illustrates a detailed view of a pivot attachment according to an embodiment of the present invention; and

FIG. 5 illustrates a detailed view of a wheel assembly according to an embodiment of the present invention.

### DETAILED DESCRIPTION OF THE INVENTION

The present invention relates to devices and methods for assisting with the movement of people. More specifically, the present invention involves devices for lifting a person from one position to another position.

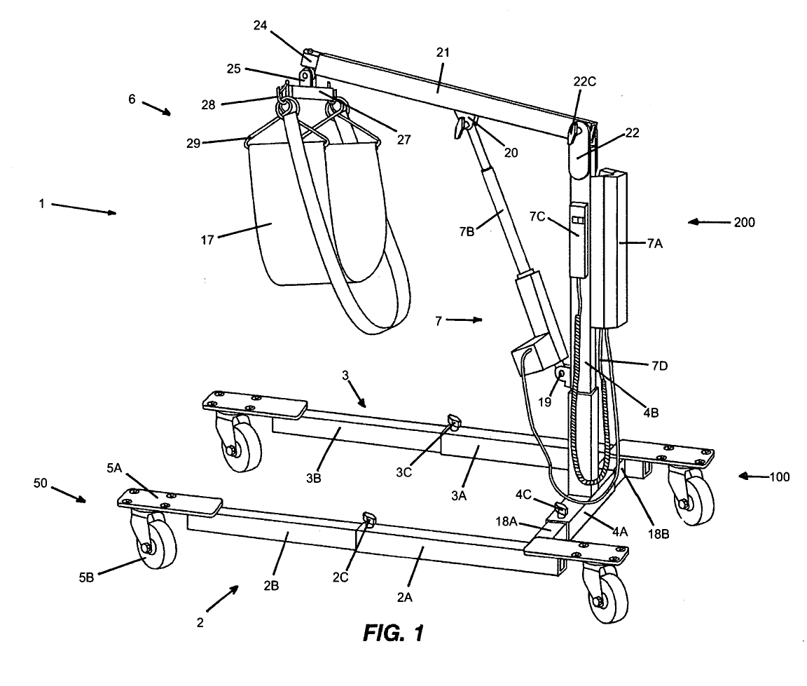

According to some embodiments of the present invention, a device 1 includes a base frame 100, a support frame 200, a lift 7, and a support structure 6. The base frame 100 and the support frame 200 may be connected to create a device 1 similar to that illustrated in FIG. 1 from which a support structure 6 may be attached. A connection between the base frame 100 and support frame 200 may be removable such that the base frame 100 and support frame 200 may be broken down or disassembled for transport or storage. The components of the base frame 100, the support frame 200 and the support structure 6 may be further broken down for storage and transport of the device 1.

The base frame 100 may include two or more legs spatially positioned to one another and capable of providing support to the device 1. In addition, the base frame 100 may include wheels or other devices for facilitating the movement of the device 1.

The support frame 200 may include members for connecting the support frame 200 to the base frame 100 and to the support structure 6. In addition, the support frame 200 may include a lift such as an electric powered lift or an electric powered hydraulic ram for moving portions of the support frame 200, thereby moving the support structure 6.

According to some embodiments of the present invention, a device 1, as illustrated in FIG. 1, includes two or more legs 2, 3, removably connected to an upstanding extension 4A which is detachably connected to an extension 4B. The extension 4B is detachably connected to an extending arm 21 by a mounting bracket 22. A lift 7 is detachably connected to the extension 4B and the extending arm 21. A support structure 6 is detachably connected to the extending arm 21.

The two or more legs 2, 3 may include multiple parts detachably connected to one another. For example, as illustrated in FIG. 1, each of legs 2 and 3 include multiple parts. Leg 2 may include a first tubular member 2A and a second tubular member 2B, wherein the second tubular member 2B may be inserted into the first tubular member 2A and moved therein to increase or decrease the overall length of leg 2. Similarly, leg 3 may include a first tubular member 3A and a second tubular member 3B, wherein the second tubular member 3B may be inserted into the first tubular member 3A and moved therein to increase or decrease the overall length of leg 3.

The first tubular members 2A and 3A of legs 2 and 3 may include fasteners 2C and 3C, respectively. The fasteners 2C and 3C may be used to secure a second tubular member 2B or 3B from moving within the first tubular member 2A or 3A such that a leg 2 or 3 is a fixed length. The fasteners 2C and 3C may include, but are not limited to, fasteners such as screws, nuts and bolts, wing-nuts, clamps, spring devices, pins and cotter pins, and other devices used for securing one movable member to another. For example, the second tubular member 2B may be moved within first tubular member 2A to produce a desired length for leg 2 and then fastened at the desired position using the fastener 2C, which will maintain the second tubular member 2B at the desired position within the first tubular member 2A.

Wheel assemblies 50 may be attached to the first tubular members 2A and 3A and to the second tubular members 2B and 3B to provide mobility to the device 1. A wheel assembly 50 may include a bracket 51 and a wheel device 52. The wheel device 52 may be permanently or removably attached to the bracket 51. A wheel device 52 may include, for example, a pair of spatially positioned ears 53 extending perpendicular to a bearing assembly 56 with a wheel 57 positioned between the ears 53 and attached to the ears by an axel 55 connected through the wheel 57 to each of the ears 53 as illustrated in FIG. 5. The bearing assembly 56 may allow the wheel device 52 to rotate in a circular pattern around an axis 59 such that the wheel 57 may be positioned to move in any direction desired. The wheel device 52 may also include a locking device 54 capable of preventing wheel 57 from moving. In addition, the locking device 54 may secure the bearing assembly 56 such that the wheel device 52 will not rotate about the axis 59.

A wheel device 52 may include, for example, caster wheels having locking mechanisms. The wheel device 52 may be attached to the bracket 51 using fasteners such as, but not limited to, screws, rivets, nuts and bolts, wing-nuts, clamps, spring devices, and other suitable fastening devices. The wheel device 52 may also be permanently fixed to the bracket 51 by welding or other such fixation method.

The bracket 51 of a wheel assembly 50 may be permanently or removably secured to a tubular member of the legs 2 and 3 as illustrated in FIGS. 1 and 5. The bracket 51 may be welded to a tubular member or secured to a tubular member with screws, rivets, nuts and bolts, wing-nuts, clamps, spring devices, pins and cotter pins, or other suitable fastening or securing devices. Multiple wheel assemblies 50 may be attached to the legs 2 and 3 such that the entire device 1 may be moved using the wheel assemblies 50. In some embodiments of the present invention four wheel assemblies 50 may be secured to the legs 2 and 3 to provide movement capabilities. In other embodiments of the present invention, fewer wheel assemblies 50 may be used. For example, wheel assemblies 50 could be secured to the second tubular members 2B and 3B but not to the first tubular members 2A and 3A. Instead, fixed supports (not shown) could be attached to the first tubular members 2A and 3A such that movement of the device 1 would be accomplished using the two wheel assemblies 50 attached to the second tubular members 2B and 3B.

The legs 2 and 3 may also include attachment elements 18A and 18B securely fixed to the legs. The attachment elements 18A and 18B may extend perpendicularly from the first tubular members 2A and 3A, as illustrated in FIG. 1, and may be permanently or removably attached thereto. For example, the attachment elements 18A and 18B may be permanently fixed to the first tubular members 2A and 3A by a welded joint. Alternatively, the attachment elements 18A and 18B may be attached to the first tubular members 2A and 3A by fasteners (not shown) such as screws, nuts and bolts, wing-nuts, clamps, spring devices, pins and cotter pins, and other devices used for securing one movable member to another.

The attachment elements 18A and 18B are preferably detachably connected to an upstanding extension 4A at the opposing end to which they are attached to the first tubular members 2A and 3A as illustrated in FIG. 1. The attachment elements 18A and 18B may be tubular members that fit into, and are movable within, tubular members of the upstanding extension 4A. Alternatively, tubular members of the upstanding extension 4A may fit into, and be moveable within, the attachment elements 18A and 18B. The attachment elements 18A and 18B may be secured to the upstanding extension 4A by fasteners 4C. The fasteners 4C may be used to secure an attachment element 18A or 18B from moving within the tubular member of the upstanding extension 4A. For example, the distance between the legs 2 and 3 may be adjusted by moving the attachment elements 18A and 18B within the upstanding extension 4A and securing them at a desired position. The fasteners 4C used to secure the attachment elements 18A and 18B within the tubular members of the upstanding extension 4A may include, but are not limited to, fasteners such as screws, nuts and bolts, wing-nuts, clamps, spring devices, pins and cotter pins, and other devices used for securing one movable member to another.

The upstanding extension 4A is preferably an inverted ‘T’ shaped tubular member open at all three ends such that the attachment elements 18A and 18B are positioned in opposing openings of the upstanding extension 4A as illustrated in FIG. 1. An extension 4B is movably positioned in the third opening of the upstanding extension 4A. The extension 4B may include a tubular member that fits within the upstanding extension 4A such that the extension 4B may be moved within the upstanding extension 4A. A fastener (not shown) may be used to secure the extension 4B from moving within the upstanding extension 4A. For example, the height of the extension 4B may be increased or decreased by moving the extension 4B within the upstanding extension 4A and then fastening the extension 4B in the desired position using a fastener. The fastener may include, but is not limited to, fasteners such as screws, nuts and bolts, wing-nuts, clamps, spring devices, pins and cotter pins, and other devices used for securing one movable member to another.

According to other embodiments of the present invention, the upstanding extension 4A need not be a ‘T’ shaped tubular member. In such embodiments, the upstanding extension 4A need only be connectable to the attachment elements 18A and 18B as well as the extension 4B.

In still other embodiments of the present invention, an upstanding extension support may replace the combination of the upstanding extension 4A and the extension 4B such that the upstanding extension support is detachably connected to the legs 2 and 3 as well as an extending arm 21.

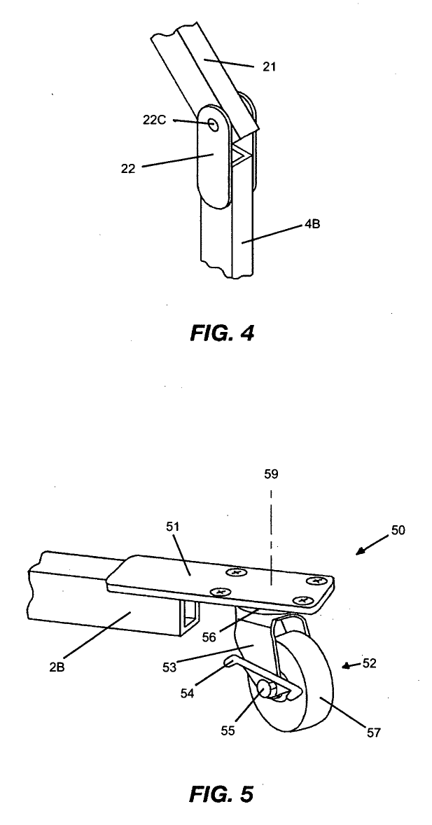

An extending arm 21 includes a tubular member that is movably attached to the extension 4B by a mounting bracket 22 at a first end as illustrated in FIG. 1. The extending arm may be pivoted around a pivot point formed by the mounting bracket 22. The mounting bracket 22 includes a pivot attachment 22C which secures the extending arm 21 to the extension 4B while allowing the extending arm 21 to rotate about the pivot attachment 22C. The pivot attachment 22C may include, but is not limited to, fasteners such as screws, nuts and bolts, wing-nuts, clamps, spring devices, pins and cotter pins, bearing devices and other devices that will allow rotation of the extending arm 21 about the pivot attachment 22C. An example of the extending arm 21 attached to the extension 4B about the pivot attachment 22C of the mounting bracket 22 is illustrated in FIG. 4.

According to some embodiments of the present invention, the support structure 6 includes a connection element 25 fixed to a laterally extending bar 27. The laterally extending bar 27 may be permanently or detachably connected to the connection element 25 and it may include hooks or hangers 28 at either end of the laterally extending bar 27. The hangers 28 may be locking hangers or free hangers adapted to accept a ring or hanging device 29 and support the hanging device 29. One or more slings or straps 17, and preferably two slings 17A and 17B, for supporting a person's weight are attached to the hanging device 29 and are hung by the hanging device 29 on the hangers 28 of the support structure 6 as illustrated in FIG. 1.

The support structure 6 may include bars, slings, and similar devices that are commonly used with mobility devices to move people or assist with the movement of people from one position to another. For example, the sling 17 may include a single sling or multiple slings. Commercially available slings used for different purposes such as supporting a person during bathing or the changing of clothes may be used with various embodiments of the present invention.

The second end of the extending arm 21 may be removably connected to the support structure 6 adapted to receive and retain a user or a person. The extending arm 21 may be fitted with a coupling 24 or other connection device for receiving the connection element 25 of the support structure 6 and removably attaching the support structure 6 to the extending arm 21. For example, as illustrated in FIG. 1, the coupling 24 receives the connection element 25 of the support structure 6 and fastens the support structure 6 to the device 1. The support structure 6 may rotate and/or pivot about the connection between the coupling 24 and the connection element 25.

A lift 7 may be secured to the extending arm 21 and the extension 4B or upstanding extension 4A. The lift 7 includes two ends, a first end at the base of the lift 7 and attached to the extension 4B or upstanding extension 4A and a second end at the end of an extendable arm 7B and attached to the extending arm 21. The lift 7 may also include a power source 7A as illustrated in FIG. 1.

According to some embodiments of the present invention, the lift 7 may be an electric powered screw lift capable of moving the extending arm 21 about the pivot attachment 22C in reference to the extension 4B or upstanding extension 4A. In other embodiments of the invention the lift 7 may be an electric powered or electrically powered hydraulic mechanism capable of moving the extending arm 21 about the pivot attachment 22C in reference to the extension 4B or upstanding extension 4A. The lift 7 may be powered by a power source 7A which can include, but is not limited to, a battery power source, an electric power source, or any other power source capable of powering the lift 7. Commercially available battery sources as used with mobility devices can be used with embodiments of the present invention.

The lift 7, according to some embodiments of the present invention, may also include a control unit 7C for operating the lift 7. The control unit 7C may be connected to the lift 7 by a cable 7D as illustrated in FIG. 1. Alternatively, the control unit 7C may control the lift 7 via remote control such as by radio frequency controls, infrared controls, or other wireless type controls. A control unit 7C facilitates the operation of the lift 7 and the device 1 by a user.

The lift 7 may be attached to the upstanding extension 4A or extension 4B by a bracket 19. The bracket 19 may include a clevis fitting adapted to receive one end of the lift 7 and movably secure it to the upstanding extension 4A or extension 4B. The bracket 19 allows the lift 7 to pivot about a bracket pivot point so that the lift 7 moves in relation to the upstanding extension 4A or extension 4B. The bracket 19 may include, but is not limited to, devices that would allow the lift 7 to be attached to the upstanding extension 4A or extension 4B such that the lift 7 can pivot on the bracket 19 with respect to the upstanding extension 4A or extension 4B. For purposes of illustration, FIG. 1 shows the lift 7 attached to the extension 4B by bracket 19.

The second end of the lift 7, at the end of an extendable arm 7B, may be attached to the extending arm 21 by a second bracket 20. The second bracket 20 is mounted to the extending arm 21 and may allow the expandable arm 7B of the lift 7 to be removably attached to the extending arm 21. The second bracket 20 also provides a pivot point about which the extending arm 21 may move in relation to the expandable arm 7B of the lift 7. As the expandable arm 7B is extended, it pushes the extending arm 21 which allows the extending arm 21 to pivot about the pivot attachment 22C. As the expandable arm 7B is retracted by the lift 7, the extending arm 21 is pulled, allowing the extending arm 21 to pivot in an opposite direction about the pivot attachment 22C.

According to some embodiments of the present invention, the second bracket 20 may include a pair of ears between which the end of the extendable arm 7B may be removably fastened to the second bracket 20 by a pivot joint. The pivot joint may include, but is not limited to, fasteners such as screws, nuts and bolts, wing-nuts, clamps, spring devices, pins and cotter pins, and other devices used for securing a pivotable member to another member.

According to embodiments of the present invention, the tubular members of the device 1 may be square tubing, rectangular tubing, round tubing, or tubing of other shapes and sizes. Alternatively, the components of the present invention, such as the legs and extension members, may be solid pieces of a suitable material, such as steel, wood, carbon fiber, or other material, welded together or secured in such a manner that they are not movable or capable of being taken apart. For example, the device 1 illustrated in FIG. 1 could include leg members of a fixed length having attachment elements welded to an upstanding extension that includes the upstanding extension and the extension. An extending arm mounted to the extension pieces would be movable using the lift and the support structure could be detachably connected to the extending arm or fixed to the extending arm. The device may or may not include wheel assemblies.

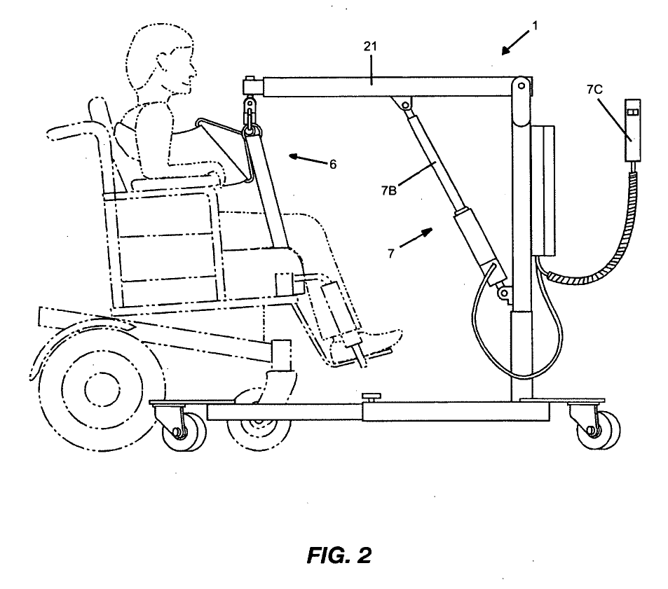

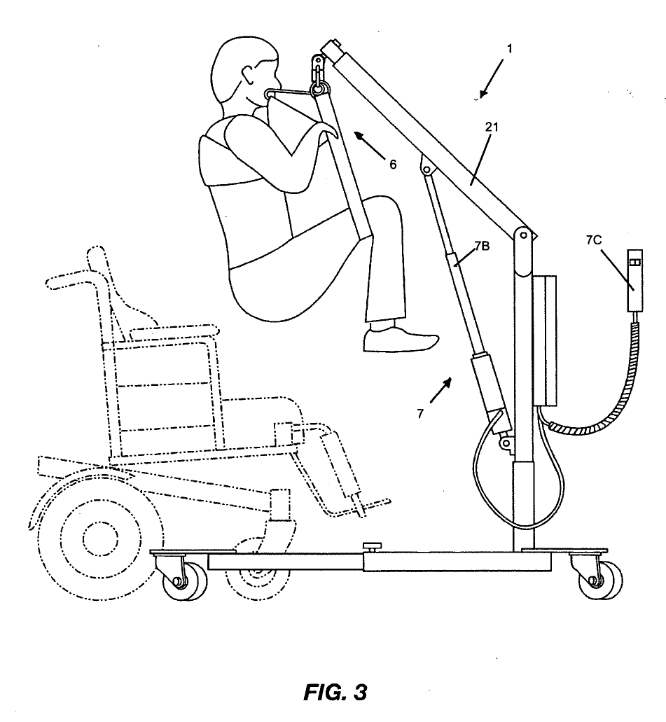

According to other embodiments of the present invention, a device 1, as illustrated in FIG. 1, may be used to move a person from one position to another. For example, a person using a wheelchair could use the device to assist them to move from their wheelchair to another location. Examples of further embodiments of the present invention are illustrated in FIGS. 2 and 3.

FIG. 2 illustrates use of the device 1 according to some embodiments of the present invention. The device 1 may be moved such that a wheelchair fits between the legs 2 and 3 of the device 1. The legs 2 and 3 may be extended or retracted by moving the tubular members of the legs 2 and 3 to provide the desired stability for the device 1. Furthermore, the attachment elements 18A and 18B may be adjusted to accommodate wheelchairs having different widths. Using the control unit 7C, the lift 7 may be lowered by retracting the extendable arm 7B, which in turn lowers the extending arm 21. The slings 17A and 17 B of the support structure 6 are placed around the torso and the legs of a person in the wheelchair as illustrated in FIG. 2. Other support structure 6 mechanisms may be used to secure a person in a wheelchair to the device 1.

As illustrated in FIG. 3, the control unit 7C may be used to extend the extendable arm 7B of the lift 7 and raise the extending arm 21 of the device 1. When raised, the extending arm 21 raises the support structure 6 and supports the person, lifting them out of the wheelchair. The device 1 may then be moved to position the person in a new location. Using the control unit 7C, the lift 7 may be lowered and the person located in a new position, such as in a vehicle or in a chair.

According to some embodiments of the present invention, the device 1 may be easily disassembled for transportation or for storage. Many mobility devices used to move people from one position to another or from one location to another are not easily disassembled for transportation. The fasteners used with various embodiments of the present invention allow various portions of the device 1 to be easily disassembled and reassembled, thereby providing excellent portability to the device 1. For example, the device may be used to assist a person out of a wheelchair and into a vehicle. The device 1 may be disassembled, loaded onto the vehicle, and transported with the individual to a new location where it can be reassembled and used to move the person out of the vehicle.

According to other embodiments of the present invention, the upstanding extension 4A may rotate in a circle about the legs 1 and 3 of the device 1 such that when a person is lifted by the device 1, the upstanding extension 4A may be rotated, thereby moving the person without moving the device 1.

According to still other embodiments of the invention, the device 1 may include a drive system for providing controlled movement to the device 1. The drive system may be remotely operated and allows the device to be controllably moved. Using such embodiments, a person in a wheelchair could remotely maneuver the device 1 to their location, pick them up, and move them to another location. The device 1 could be controlled by the person in the wheelchair or by another individual.

Having thus described certain preferred embodiments of the present invention, it is understood that the invention defined by the appended claims is not to be limited by particular details set forth in the above description, as many apparent variations thereof are possible without departing from the spirit or scope thereof as hereinafter claimed.

1. A lifting device, comprising:
a base frame comprising two or more legs;
a support frame comprising an extension and an extended arm, said support frame detachably connected to said base frame;
a lift detachably connected to said extension and said extended arm and configured to move the extended arm relative to said extension; and
a support structure detachably connected to said extended arm.

2. The lifting device of claim 1, wherein at least one of said two or more legs comprises:
a first tubular member having at least one open end;
a second tubular member, wherein at least a portion of said second tubular member is inserted into an open end of said first tubular member; and
a fastening device, wherein said fastening device secures a portion of said second tubular member inside said first tubular member.

3. The lifting device of claim 2, wherein said tubular members comprise round tubular members.

4. The lifting device of claim 2, wherein said tubular members comprise square tubular members.

5. The lifting device of claim 2, wherein said fastening device is selected from the group consisting of screws, nuts and bolts, wing-nuts, clamps, spring devices, pins, and cotter pins.

6. The lifting device of claim 1, further comprising at least one wheel assembly attached to each of said two or more legs.

7. The lifting device of claim 6, wherein said wheel assembly comprises:
a bracket;
a wheel device supporting a wheel, wherein said wheel device is attached to said bracket and comprises:
a bearing assembly;
a pair of spatially positioned ears extending perpendicularly from said bearing assembly;
a wheel positioned between said pair of spatially positioned ears; and
an axel movably fixing said wheel between said pair of spatially positioned ears.

8. The lifting device of claim 1, wherein said lift comprises an electrically powered hydraulic lift.

9. The lifting device of claim 1, wherein said lift comprises:
an electrically powered screw lift;
a power source; and
a control unit for controlling movement of the electrically powered hydraulic lift.

10. The lifting device of claim 1, wherein said support structure comprises:
a first sling; and
a second sling, wherein said first sling and said second sling are movably attached to said extended arm.

11. A lifting device, comprising:
an upstanding extension support,
a first leg detachably connected to the upstanding extension support;
a second leg detachably connected to the upstanding extension support;
an extending arm detachably connected to the upstanding extension support;
a lift detachably connected between the upstanding extension support and the extending arm; and
a support structure detachably connected to the extending arm.

12. The lifting device of claim 11, wherein said upstanding extension support comprises:
an upstanding extension; and
an extension detachably connected to the upstanding extension, wherein said first leg and said second leg are detachably connected to the upstanding extension.

13. The lifting device of claim 11, wherein said first leg further comprises:
a first tubular member having at least one open end;
an attachment element connected to said first tubular member and detachably connected to the upstanding extension support;
a second tubular member, wherein at least a portion of said second tubular member is inserted into an open end of said first tubular member; and
a fastening device, wherein said fastening device detachably secures a portion of said second tubular member inside said first tubular member.

14. The lifting device of claim 11, wherein said second leg further comprises:
a first tubular member having at least one open end;
an attachment element connected to said first tubular member and detachably connected to the upstanding extension support;
a second tubular member, wherein at least a portion of said second tubular member is inserted into an open end of said first tubular member; and
a fastening device, wherein said fastening device detachably secures a portion of said second tubular member inside said first tubular member.

15. The lifting device of claim 11, further comprising fastening devices for connecting the detachable connections, wherein the fastening devices are selected from the group consisting of screws, nuts and bolts, wing-nuts, clamps, spring devices, pins, and cotter pins.

16. The lifting device of claim 11, further comprising:
at least one first leg wheel assembly connected to said first leg; and
at least one second leg wheel assembly connected to said second leg, wherein said first leg wheel assembly and said second leg wheel assembly each comprise:
a bearing assembly;
a pair of spatially positioned ears extending perpendicularly from said bearing assembly;
a wheel positioned between said pair of spatially positioned ears; and
an axel movably fixing said wheel between said pair of spatially positioned ears.

17. The lifting device of claim 11, wherein said support structure comprises:
a first sling; and
a second sling.

18. A lifting device, comprising:
a right leg comprising a first right leg member and a second right leg member wherein a first end of said first right leg member is inserted in a first end of said second right leg member and detachably connected thereto;
a first right leg wheel assembly attached to a second end of said first right leg member;
a second right leg wheel assembly attached to a second end of said second right leg member;
a right leg attachment element connected to said second right leg member;
a left leg comprising a first left leg member and a second left leg member wherein a first end of said first left leg member is inserted in a first end of said second left leg member and detachably connected thereto;
a first left leg wheel assembly attached to a second end of said first left leg member;
a second left leg wheel assembly attached to a second end of said second left leg member;
a left leg attachment element connected to said second left leg member;
an upstanding extension, wherein said right leg attachment element is detachably connected to said upstanding extension and said left leg attachment element is detachably connected to said upstanding extension;
an extension, wherein a first end of said extension is inserted in said upstanding extension and is detachably connected to said upstanding extension;
an extending arm detachably connected to a second end of said extension at a first end of said extending arm, said detachable connection permitting said extending arm to move relative to said extension about a pivot point in said first end of said extending arm;
a support device detachably connected to a second end of said extending arm, wherein said support device comprises at least one sling; and
an electrically powered screw lift detachably connected at a first lift end to said extension and detachably connected at a second lift end to said extending arm, wherein said lift moves said extending arm relative to said extension, said lift further comprising a power source and a control unit in communication with said lift.

19. The lift device of claim 18, wherein said extension is generally perpendicular to said right leg and said left leg.

20. The lift device of claim 18, wherein each of said detachable connections is secured by a fastening device selected from the group consisting of screws, nuts and bolts, wing-nuts, clamps, spring devices, pins, and cotter pins.
